(19) United States
(12) Patent Application Publication
(10) Pub. No.: US 2026/0061330 A1
(43) Pub. Date: Mar. 5, 2026

(54) INTERACTIVE WEB3 MARKETPLACE FOR IN-GAME ASSET ACQUISITION AND TRADE USING BLOCKCHAIN TECHNOLOGY

(71) Applicant: Dan Dogeon Lee, Ellicott City, MD (US)

(72) Inventor: Dan Dogeon Lee, Ellicott City, MD (US)

(21) Appl. No.: 18/822,307

(22) Filed: Sep. 2, 2024

(51) Int. Cl. A63F 13/85

(52) U.S. Cl. CPC A63F 13/85; A63F 2300/575

(57) ABSTRACT

Rarifye's interactive mechanics, such as stamina-based searches and rarity-based asset acquisition, introduce a gamified experience to digital asset trading. Users are encouraged to engage with the platform more frequently, as the acquisition of rare assets and the management of stamina become central aspects of gameplay. This gamified approach creates a more dynamic and engaging environment for users, differentiating Rarifye from other Web3 marketplaces that focus solely on transactions.

### TECHNICAL FIELD

The present invention relates to an interactive web3 marketplace for in-game asset acquisition and trade, in which a plurality of users may be capable of communicating with other uses, searching assets, charging stamina, and real-time trading with other users, providing, by combining blockchain security with a gamified marketplace experience, a more engaging and dynamic environment for digital asset trading.

### BACKGROUND OF THE INVENTION

The advent of blockchain technology has revolutionized various industries, most notably in finance, supply chain management, and digital assets. One of the most prominent applications of blockchain is in the realm of decentralized applications and Web3 marketplaces. These marketplaces provide a platform for the secure trading and management of digital assets, leveraging the decentralized and immutable nature of blockchain technology to ensure the transparency and security of transactions.

In recent years, the gaming industry has increasingly embraced the integration of blockchain technology, particularly in the context of in-game assets. Traditional gaming platforms often centralize control over in-game items, meaning that players do not truly own the items they acquire. Blockchain technology addresses this issue by enabling true digital ownership of in-game assets. Non-fungible tokens (NFTs) have emerged as a popular method for representing ownership of unique digital assets, including in-game items. This new paradigm has led to the rise of Web3 marketplaces tailored to the trading of NFTs and other digital assets within gaming ecosystems. Despite the growth of Web3 marketplaces, there remains a need for a more interactive and user-friendly experience that goes beyond simple asset trading. Existing platforms often focus solely on the transaction aspect, leaving little room for engagement or entertainment. Gamers, who are accustomed to engaging and immersive experiences, may find current blockchain-based marketplaces lacking in these areas.

To address this gap, there is a need for a Web3 marketplace that not only provides the security and transparency of blockchain-based transactions but also offers an engaging, game-like experience. Such a platform would allow users to actively participate in the acquisition, management, and trading of digital assets in a way that mimics traditional gaming mechanics. This interactive approach could drive higher user engagement, making the platform more appealing to gamers and digital asset enthusiasts alike.

Rarifye is a Web3 marketplace designed to meet this demand. Built on the Polygon blockchain network, Rarifye introduces game-like elements into the process of acquiring and trading in-game assets. The platform features various interactive components, including stamina-based asset acquisition, rarity-based categorization of assets, and real-time trading with other users. By combining blockchain security with a gamified marketplace experience, Rarifye aims to create a more engaging and dynamic environment for digital asset trading.

### SUMMARY OF THE INVENTION

Disclosed is a method of obtaining and managing in-game assets according to an embodiment of the present invention. The method may include the flow of operations, starting from displaying obtainable digital assets, allowing the user to initiate a search, consuming stamina, determining asset obtainment, updating the inventory, and finally managing and trading assets on the blockchain marketplace.

The method for obtaining and managing in-game assets in a blockchain-based marketplace may involve:
displaying a set of obtainable digital assets to a user, wherein each asset has an associated likelihood of being obtained (S10);
enabling the user to initiate a search for the digital assets through an interactive interface (S20);
consuming a predetermined amount of stamina for each search attempt by the user (S30);
determining, based on the consumed stamina and the associated likelihood, whether the user obtains one or more digital assets (S40);
updating the user's inventory with the obtained digital assets, wherein the inventory is displayed in an order based on the rarity of the assets (S50); and
allowing the user to view, trade, and list the obtained assets on a blockchain-based marketplace (S60).

The stamina may be incrementally consumed per second during the search, and the user can manually stop the search to conserve stamina. Also, the digital assets obtained have background colors representing their rarity, including but not limited to purple, red, blue, green, white, and black, with each color corresponding to a predefined probability. The user's inventory may also display the last sale price and the existing count of each asset, and assets with fewer existing copies are displayed first.

The method is not limited to the above-referenced steps, and may be modified into a method comprising further methods. Alternatively, according to an embodiment of the present invention, the method may be modified to allow for trading digital assets in a decentralized marketplace.

In an embodiment, the method may include the process of trading digital assets, beginning with the selection of digital assets, displaying a list of users, selecting a user for trade, presenting the selected user's inventory, selecting assets for trade, sending a trade request, and executing the trade via a smart contract on the blockchain.

More specifically, the method may include the following steps, according to an embodiment of the present invention.
Providing a user interface that allows a first user to select digital assets from their inventory (S110);
Displaying a list of available users and allowing the first user to select a second user for a trade (S120);
Presenting the first user with the second user's inventory (S130);
Enabling the first user to select assets from both inventories for trade, wherein the selected assets are displayed in “You Get” and “You Give” sections (S140);
Sending a trade request to the second user that includes the selected assets (S150);
Allowing the second user to either accept or decline the trade request (S160), and
Upon being accepted, executing the trade by updating both users' inventories on the blockchain (S170).

The user interface may be able to provide search functionality to locate specific users for trading, and the trade request includes metadata such as the rarity, existing count, and last sold price of the digital assets involved in the trade. In addition, the execution of the trade is conducted via a smart contract on the blockchain, ensuring transparency and security of the transaction.

### BRIEF DESCRIPTION OF THE DRAWINGS

The accompanying drawings are included to provide a further understanding of the present invention and are incorporated in and constitute a part of this specification. The drawings illustrate exemplary embodiments of the present invention and, together with the description, serve to explain principles of the present invention. In the drawings:

FIG. 1 is a view illustrating a web-page for a home tab featuring a chat function according to an embodiment of the present invention;

FIG. 2 is a view illustrating a web-page for a profile tab where users manage their profile information according to an embodiment of the present invention;

FIG. 3 is a view illustrating a web-page for a forage tab, allowing users to acquire digital assets, according to an embodiment of the present invention;

FIG. 4 is a view illustrating a web-page for a stamina tab for displaying and charging a user's stamina level, according to an embodiment of the present invention;

FIG. 5 is a view illustrating an inventory web-page where users view inventory assets according to an embodiment of the present invention;

FIG. 6 is a view illustrating a web-page for trading, in which users' assets are exchanged with each other according to an embodiment of the present invention;

FIG. 7 is a view illustrating a web-page for a marketplace according to an embodiment of the present invention;

FIGS. 8 and 9 are block diagrams illustrating a method for obtaining and managing in-game assets according to an embodiment of the present invention. ; and

FIG. 10 is a block diagram illustrating a method for trading digital assets in a decentralized marketplace according to an embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Elements and components disclosed in the drawings may be exaggerated or simplified to improve the clarity and convenience of the description. Terms or languages defined in the present disclosure may have different meaning according to the users' intention or practice. These terms should be interpreted as a meaning corresponding to the technical concept of the present invention disclosed throughout the specification of the present invention.

As used herein, the singular forms “a,” “an,” and “the” are intended to include the plural forms as well, unless the context clearly indicates otherwise. In addition, the expressions defining the relationship of elements or components should be interpreted as broad as possible. For example, it will be understood that when an element or layer is referred to as being “on,” “connected to,” “coupled to,” or “adjacent to” another element or layer, it can be directly on, connected, coupled, or adjacent to the other element or layer, or intervening elements or layers may be present therebetween. It will also be understood that when an element is same or identical to another element, the element can be completely same or identical to another element, or it includes that the two elements may be “substantially” similar to each other. In the same manner, for the expression showing the equivalence of time such as “simultaneously” or “at the same time,” it should be understood that it happens completely at the same time, or they may happen at substantially the similar time. The same reference denotations may be used to refer to the same or substantially the same elements throughout the specification and the drawings.

Rarifye is a decentralized Web3 marketplace that allows users to acquire, manage, and trade in-game assets in a secure and interactive environment. The platform is built on the Polygon blockchain network, which enables fast and cost-effective transactions. Rarifye introduces several unique features that differentiate it from traditional Web3 marketplaces, including stamina-based asset acquisition, rarity-based categorization, and interactive trading mechanics.

Hereinafter, an interactive web3 marketplace for in-game asset acquisition and trade, including an in-depth overview of the functionalities and mechanics of the Rarifye platform, will be described in detail with reference to the accompanying drawings.

### Home Tab

The Home tab serves as the central hub for user interaction. It includes a chat function that allows users to communicate with each other in real-time. Each message sent in the chat is timestamped and displayed under the sender's username and profile picture, creating a social experience within the platform. The chat feature enhances the community aspect of the marketplace, encouraging users to interact and engage with one another while participating in asset trading and acquisition.

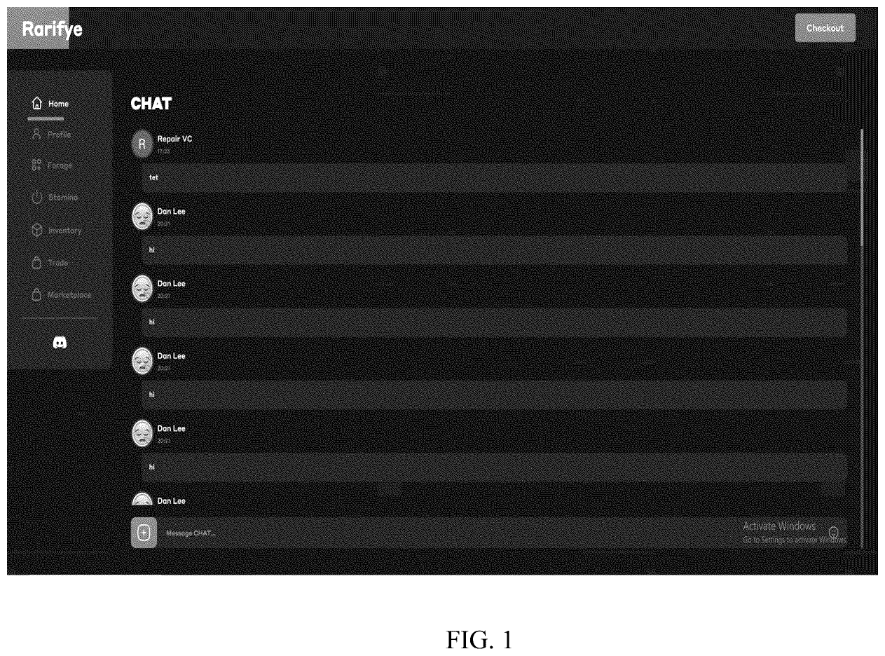

FIG. 1 is a view illustrating a web-page for the home tab featuring a chat function according to an embodiment of the present invention.

### Profile Tab

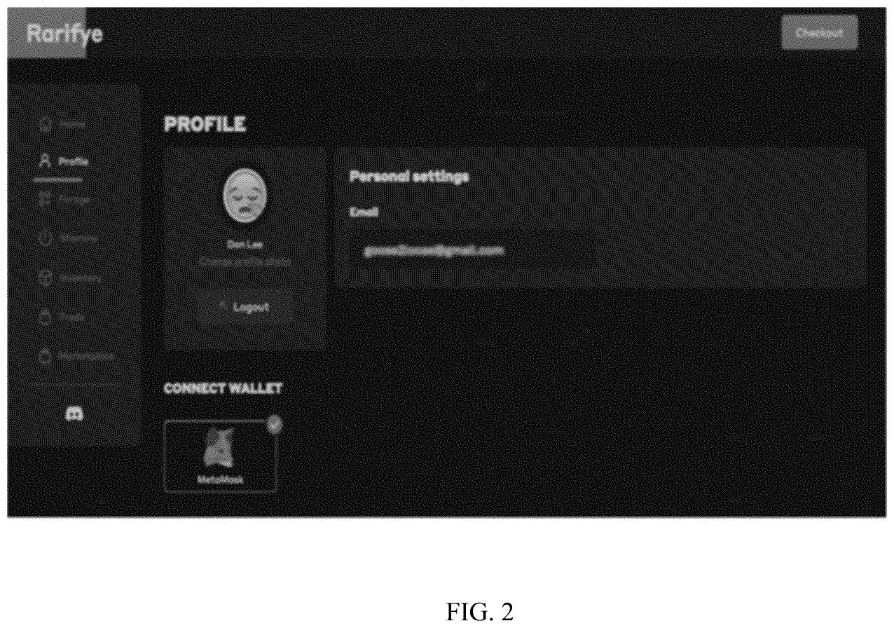

FIG. 2 is a view illustrating a web-page for the profile tab where the user manages their profile information. The Profile tab provides users with access to their personal settings, including their name, email, and profile picture. Users can also connect and disconnect their MetaMask wallet from this tab, which is essential for conducting transactions on the platform. Additionally, the Profile tab allows users to log out of their account, ensuring the security of their personal information and digital assets.

### Forage Tab

The Forage tab is one of the core features of Rarifye, where users can actively acquire digital assets. Each week, a new set of assets is introduced to the platform, and users can obtain these assets through an interactive search mechanism. The Forage tab displays the user's current stamina count, which is consumed as they search for assets. Users initiate the search by clicking the “Search” button, which consumes one stamina point per second until the user clicks the “Stop” button. Each stamina point consumed provides the user with a chance to obtain an asset, with the likelihood of obtaining specific assets varying based on their rarity.

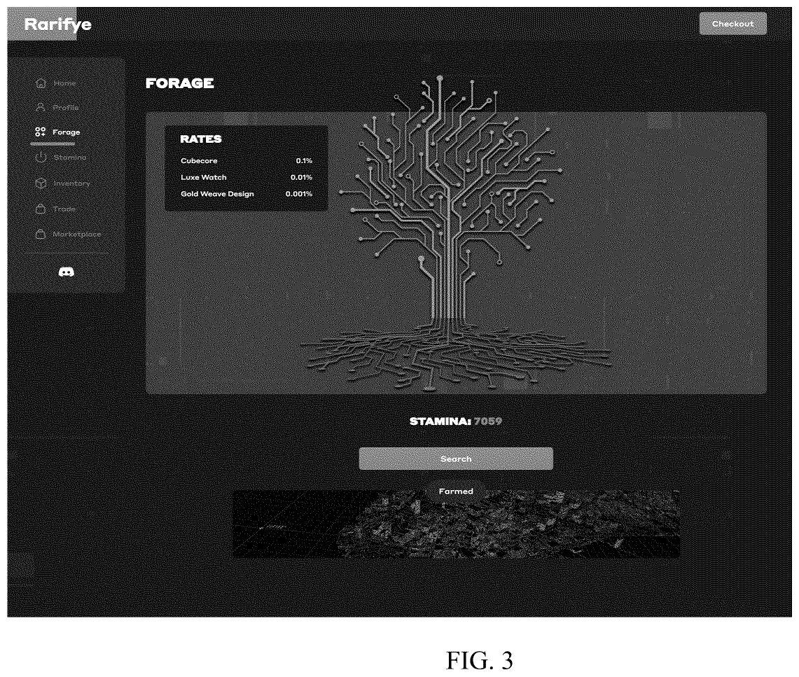

FIG. 3 is a view illustrating a web-page for the forage tab in which users may be able to acquire digital assets, according to an embodiment of the present invention.

Assets obtained through the Forage tab are displayed in a “Farmed” box, which appears below the “Search” button. The assets have different background colors that indicate their rarity. For example, assets with a purple background are the most common, with a 90% likelihood of being obtained. Rarer assets have background colors such as red, blue, and green, each with a 3% chance of being obtained, while the rarest assets have white and black backgrounds, each with a 0.5% chance.

This interactive asset acquisition system introduces an element of chance and strategy, as users must manage their stamina and decide when to stop searching to maximize their chances of obtaining rare assets.

### Stamina Tab

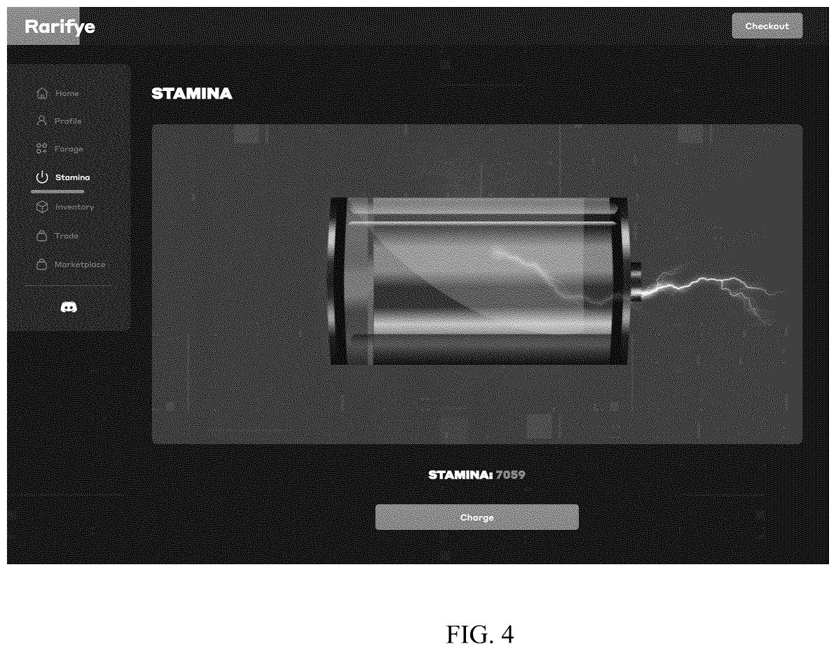

FIG. 4 is a view illustrating a web-page for a stamina tab for displaying and charging a user's stamina level. The Stamina tab displays the user's current stamina count, which is crucial for asset acquisition in the Forage tab. Users can increase their stamina by clicking the “Charge” button, which increments their stamina by one point every second until they click the “Stop” button or navigate away from the tab. The stamina system adds a layer of resource management to the platform, requiring users to balance their stamina consumption with their desire to acquire assets.

### Inventory Tab

The Inventory tab provides users with an overview of all the assets they own. Each asset is displayed with its “existing count,” which indicates the number of copies currently existing in the game. Additionally, the Inventory tab shows the last price each asset was sold for in USD (e.g., “Last sold for: $10”). The assets are listed in ascending order of their existing count, meaning that assets with fewer copies appear first in the inventory. This rarity-based display system helps users quickly identify their most valuable assets.

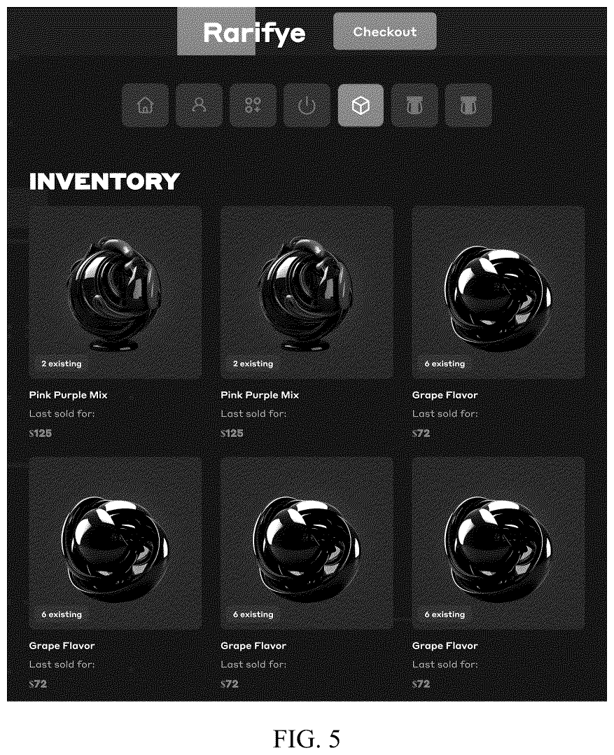

FIG. 5 is a view illustrating an inventory web-page where users may be able to view all of the assets according to an embodiment of the present invention.

### Trade Tab

The Trade tab is divided into two sub-tabs: “Send Trade” and “Incoming Trades. ” The “Send Trade” sub-tab allows users to initiate trades with other players by selecting assets from their own inventory and proposing a trade to another user. Users can search for other users via a search bar and view the selected user's inventory. Once assets are selected from both inventories, they are displayed in “You Get” and “You Give” boxes, and the user can send the trade request.

The “Incoming Trades” sub-tab shows all trade requests received by the user. Each trade request includes details of the proposed trade and the sending user. Users can choose to accept or decline each trade request. Accepting a trade exchanges the assets as stated, while declining the trade cancels the request. The Trade tab introduces a peer-to-peer trading system that allows users to exchange assets with one another in a secure and transparent manner.

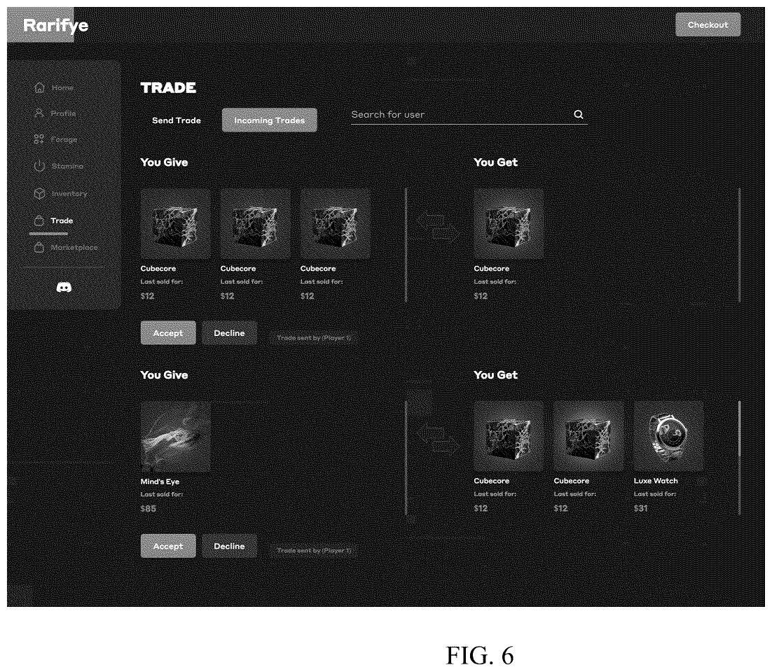

FIG. 6 is a view illustrating a web-page for trading where users' assets are exchanged with each other according to an embodiment of the present invention.

### Marketplace Tab

The Marketplace tab enables users to list their assets for sale to other users. By clicking the “List” button, users are taken to a page similar to their inventory page, where they can select an asset to list. After selecting an asset, users can set a price in USD. Once listed, the asset appears on the marketplace for other users to purchase.

The Marketplace tab includes two sub-tabs: “All Listings” and “My Listings. ” The “All Listings” sub-tab displays all listings from all users, organized in ascending order of the existing count of each asset. The “My Listings” sub-tab displays the user's own listings, providing them with an overview of their assets currently available for sale. Each listing shows the price in both USD and MATIC, the existing count of the asset, the last sold price, and the lowest price of that asset currently listed. Users can purchase other users' listings, which leads to a checkout page where they can confirm the purchase and pay via their MetaMask wallet. Upon successful payment, the asset is added to the purchaser's inventory.

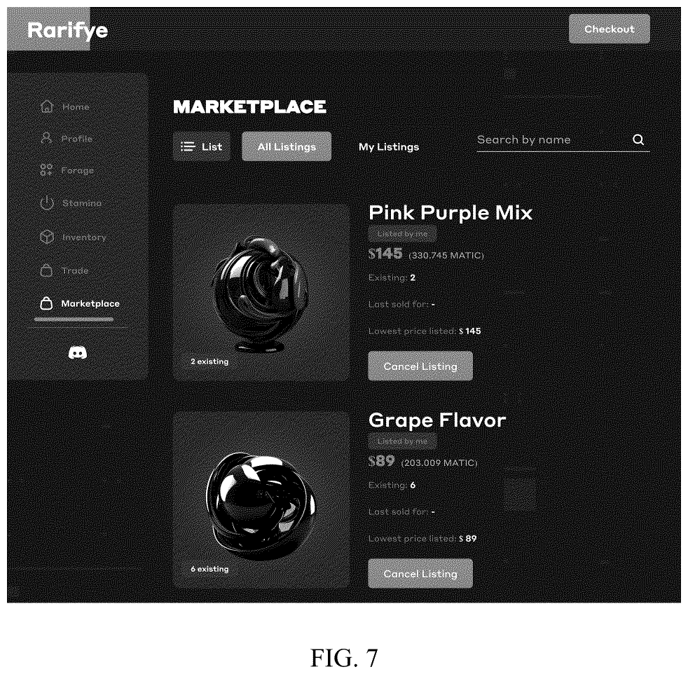

FIG. 7 is a view illustrating a web-page for the marketplace according to an embodiment of the present invention.

### Blockchain Integration

All transactions on the Rarifye platform, from asset acquisition to trades and marketplace sales, are recorded on the Polygon blockchain. This integration ensures that all transactions are transparent, secure, and immutable. The use of blockchain technology guarantees that users have true ownership of their digital assets, and all transaction data is permanently recorded on the blockchain.

Smart contracts are utilized to facilitate transactions on the platform. These smart contracts automatically execute the terms of an agreement between users, ensuring that all trades and sales are conducted securely and without the need for intermediaries. By leveraging blockchain technology and smart contracts, Rarifye provides a decentralized marketplace experience that is both secure and user-friendly.

### Interactive Mechanics

Rarifye's interactive mechanics, such as stamina-based searches and rarity-based asset acquisition, introduce a gamified experience to digital asset trading. Users are encouraged to engage with the platform more frequently, as the acquisition of rare assets and the management of stamina become central aspects of gameplay. This gamified approach creates a more dynamic and engaging environment for users, differentiating Rarifye from other Web3 marketplaces that focus solely on transactions.

Hereinafter, a method of obtaining and managing in-game assets according to an embodiment of the present invention will be described in greater detail with reference to the accompanying drawings.

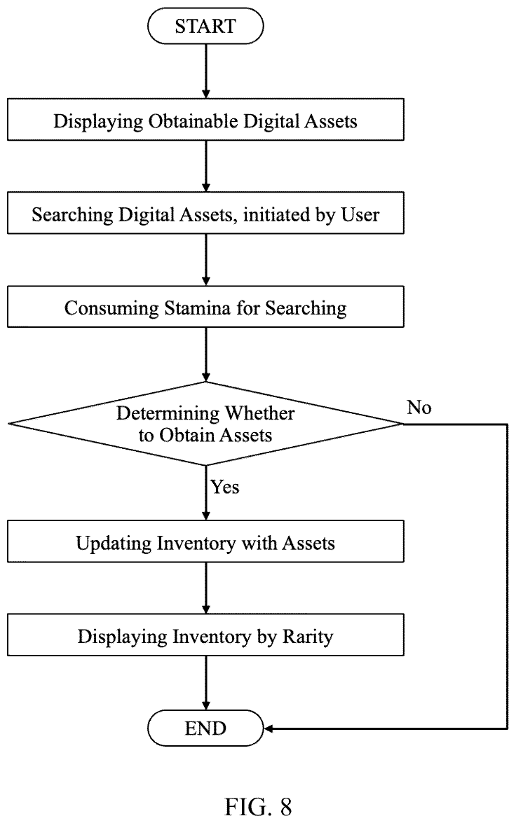

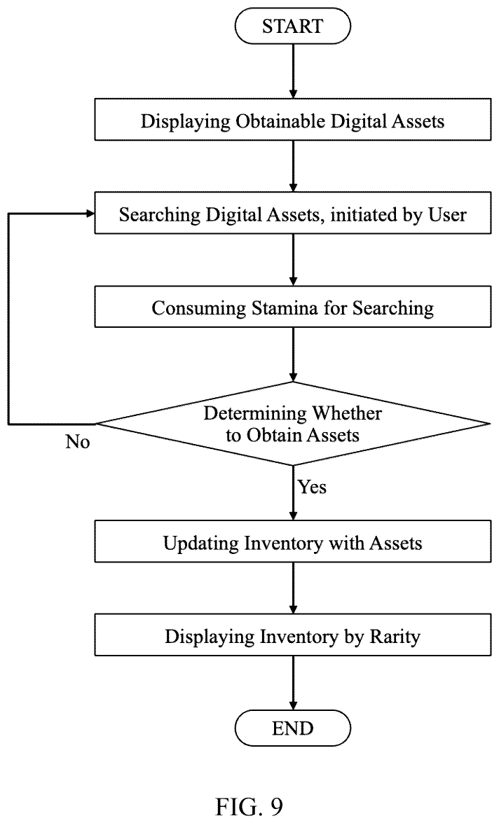

FIGS. 8 and 9 are block diagrams illustrating the method for obtaining and managing in-game assets according to an embodiment of the present invention. The diagrams illustrate the flow of operations, starting from displaying obtainable digital assets, allowing the user to initiate a search, consuming stamina, determining asset obtainment, updating the inventory, and finally managing and trading assets on the blockchain marketplace.

The method for obtaining and managing in-game assets in a blockchain-based marketplace may involve:
displaying a set of obtainable digital assets to a user, wherein each asset has an associated likelihood of being obtained (S10);
enabling the user to initiate a search for the digital assets through an interactive interface (S20);
consuming a predetermined amount of stamina for each search attempt by the user (S30);
determining, based on the consumed stamina and the associated likelihood, whether the user obtains one or more digital assets (S40);
updating the user's inventory with the obtained digital assets, wherein the inventory is displayed in an order based on the rarity of the assets (S50); and
allowing the user to view, trade, and list the obtained assets on a blockchain-based marketplace (S60).

The stamina may be incrementally consumed per second during the search, and the user can manually stop the search to conserve stamina. Also, the digital assets obtained have background colors representing their rarity, including but not limited to purple, red, blue, green, white, and black, with each color corresponding to a predefined probability. The user's inventory may also display the last sale price and the existing count of each asset, and assets with fewer existing copies are displayed first.

Hereinafter, a method of trading digital assets in a decentralized marketplace according to an embodiment of the present invention will be described in more details with reference to the accompanying drawing.

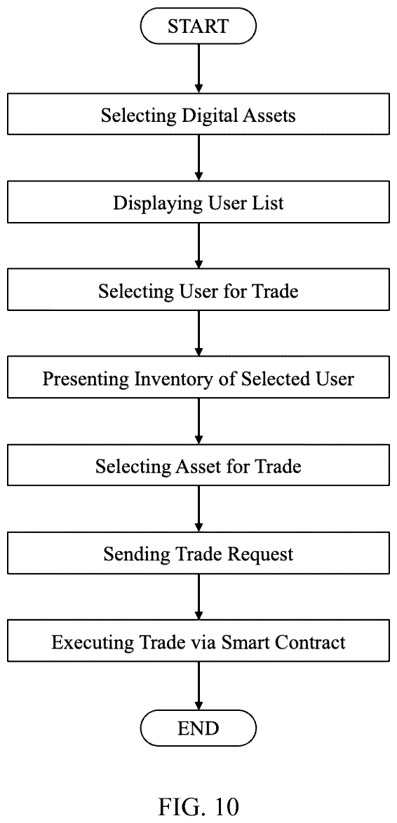

FIG. 10 is a block diagram illustrating the method for trading digital assets in a decentralized marketplace according to an embodiment of the present invention.

FIG. 10 outlines the process of trading digital assets, beginning with the selection of digital assets, displaying a list of users, selecting a user for trade, presenting the selected user's inventory, selecting assets for trade, sending a trade request, and executing the trade via a smart contract on the blockchain.

The method may be specifically configured to include steps of:
providing a user interface that allows a first user to select digital assets from their inventory (S110);
displaying a list of available users and allowing the first user to select a second user for a trade (S120);
presenting the first user with the second user's inventory (S130);
enabling the first user to select assets from both inventories for trade, wherein the selected assets are displayed in “You Get” and “You Give” sections (S140);
sending a trade request to the second user that includes the selected assets (S150);
allowing the second user to either accept or decline the trade request (S160), and
upon being accepted, executing the trade by updating both users' inventories on the blockchain (S170).

Here, the user interface may be able to provide search functionality to locate specific users for trading, and the trade request includes metadata such as the rarity, existing count, and last sold price of the digital assets involved in the trade.

In addition, the execution of the trade is conducted via a smart contract on the blockchain, ensuring transparency and security of the transaction.

These methods for obtaining, managing, and trading in-game assets in a blockchain-based environment are described. The above descriptions are provided for illustrative purposes of the technical concepts of the present invention, and it is obvious that a person having ordinary skill in the art may variously modify and change without departing from the natural characteristics of the present invention. Therefore, the exemplary embodiments disclosed in the present invention are provided for the sake of descriptions, not limiting the technical concepts of the present invention, and it should be understood that such exemplary embodiments are not intended to limit the scope of the technical concepts of the present invention. The protection scope of the present invention should be understood by the claims below, and all the technical concepts within the equivalent scopes should be interpreted to be within the scope of the right of the present invention.

What is claimed is:

1. A method for obtaining and managing in-game assets in a blockchain-based marketplace, the method comprising:
displaying a set of obtainable digital assets to a user, wherein each asset has an associated likelihood of being obtained;
enabling the user to initiate a search for the digital assets through an interactive interface;
consuming a predetermined amount of stamina for each search attempt by the user;
determining, based on the consumed stamina and the associated likelihood, whether the user obtains one or more digital assets;
updating the user's inventory with the obtained digital assets, wherein the inventory is displayed in an order based on the rarity of the assets;
allowing the user to view, trade, and list the obtained assets on a blockchain-based marketplace.

2. The method of claim 1, wherein the stamina is incrementally consumed per second during the search, and the user can manually stop the search to conserve stamina.

3. The method of claim 2, wherein the digital assets obtained have background colors representing their rarity, including but not limited to purple, red, blue, green, white, and black, with each color corresponding to a predefined probability.

4. The method of claim 3, wherein the user's inventory displays the last sale price and the existing count of each asset, and assets with fewer existing copies are displayed first.

5. A method for trading digital assets in a decentralized, blockchain-based marketplace, the method comprising:
providing a user interface that allows a first user to select digital assets from their inventory;
displaying a list of available users and allowing the first user to select a second user for a trade;
presenting the first user with the second user's inventory;
enabling the first user to select assets from both inventories for trade, wherein the selected assets are displayed in “You Get” and “You Give” sections;
sending a trade request to the second user that includes the selected assets;
allowing the second user to either accept or decline the trade request, and if accepted, executing the trade by updating both users' inventories on the blockchain.

6. The method of claim 5, wherein the user interface provides a search functionality to locate specific users for trading.

7. The method of claim 6, wherein the trade request includes metadata such as the rarity, existing count, and last sold price of the digital assets involved in the trade.

8. The method of claim 7, wherein the execution of the trade is conducted via a smart contract on the blockchain, ensuring transparency and security of the transaction.
